(19) United States
(12) Patent Application Publication
(10) Pub. No.: US 2026/0307341 A1
(43) Pub. Date: Oct. 8, 2026

(54) TOOLING AND METHOD FOR SHAPING A BLADE MADE OF COMPOSITE MATERIAL

(71) Applicants: SAFRAN AIRCRAFT ENGINES, Paris (FR); SAFRAN AEROSPACE COMPOSITES, LLC, Rochester, NH (US)

(72) Inventors: Matthieu Patrick Jean Roger PERLIN, Moissy-Cramayel (FR); Alexandre Rene Roger BEDLE, Moissy-Cramayel (FR); Allison GLUGLA, Moissy-Cramayel (FR); Lauren CHIN, Moissy-Cramayel (FR)

(73) Assignees: SAFRAN AIRCRAFT ENGINES, Paris (FR); SAFRAN AEROSPACE COMPOSITES, LLC, Rochester, NH (US)

(21) Appl. No.: 19/098,291

(22) Filed: Apr. 2, 2025

(51) Int. Cl. B29C 70/44; B29L 31/08

(52) U.S. Cl. CPC B29C 70/44; B29L 2031/08

(57) ABSTRACT

A tooling is for shaping an aerofoil of a blade made of composite material consisting of a fibrous reinforcement embedded in a polymer, the blade including a root and an aerofoil that radially extends the root. The tooling includes at least one shaper, a heating device, and a device for positioning the at least one shaper. The at least one shaper is shaped to conform to a portion of the aerofoil in its final shape so that the portion takes its final shape when it is heated by the heating device to a temperature close to the glass transition temperature of the polymer and simultaneously deformed by the at least one shaper using the positioning device.

In a turbomachine that extends along a longitudinal axis, air enters a duct where it is compressed by a compressor located upstream. This air then enters the combustion chamber of the turbomachine located downstream of this duct where it is mixed with fuel before being burned therein. The hot gases coming from this combustion are then expanded in a duct in a turbine located downstream of this chamber and rotate this turbine. The rotation of this turbine drives a shaft of this turbomachine on which this turbine is mounted. This shaft in turn drives the compressor and the blades of the fan located upstream of the turbomachine in rotation. The rotation of the blades of the fan contributes, together with the ejection at high speed of the gases at the outlet of the combustion chamber, to the propulsion of the turbomachine. The present invention relates to blades made of composite material, in particular the fan blades, of a turbomachine.

Such blades are manufactured by placing a fibrous preform in a mould, closing the mould then injecting under pressure a polymer that fills the mould and completely impregnates and coats the fibrous preform. Then the mould is heated to harden the polymer. This polymer is for example a thermosetting polymer such as epoxy. This method is Resin Transfer Moulding (RTM). Elements such as its leading edge are then added onto the blade. Then, in order to consolidate the blade with these elements, the blade is held in shapers and the blade is heated in an autoclave to above 100° C. The shapers contribute to maintaining the geometry of the blade during this heating cycle. The blade is then cooled to obtain the finished blade.

On the finished blade, shape deviations with respect to the desired geometry are sometimes observed. These deviations are due to uncontrolled deformations of the blade during its moulding by RTM and/or during its heating cycle in the autoclave. These deformations lead to the scrapping of these blades, which is undesirable.

### DESCRIPTION OF THE INVENTION

The present invention aims to overcome these disadvantages.

The invention aims to propose a tooling for shaping an aerofoil of a blade made of composite material consisting of a fibrous reinforcement and a polymer surrounding the fibrous reinforcement, the blade including a root intended to be housed in a cavity of a rotor and an aerofoil that radially extends this root, this tooling allowing to geometrically correct an aerofoil in the simplest manner possible to give it its desired final shape, while conferring the desired mechanical properties onto it.

This goal is achieved by the fact that the tooling comprises at least one shaper, a heating device and a device for positioning the at least one shaper, the at least one shaper being shaped to conform to a portion of the aerofoil in its final shape so that the portion takes its final shape when it is heated by the heating device to a temperature close to the glass transition temperature of the polymer and simultaneously deformed by the at least one shaper using the positioning device.

Via these arrangements, the aerofoil is given its desired final shape. The addition or the removal of material on the blade is avoided, which simplifies the shaping process. In addition, an embrittlement of the blade that could be caused by a machining during which fibres could be cut is avoided. Moreover, the use of the tooling according to the invention allows to avoid the addition or the removal of material of the aerofoil, which avoids its embrittlement.

For example, the positioning device comprises a tarpaulin and a vacuum pump.

For example, the portion is at least a part of an edge of the aerofoil.

For example, the portion is the entirety of an edge of the aerofoil.

For example, the edge is the leading edge of the aerofoil.

For example, the at least one shaper comprises a first shaper that is capable of conforming to a first face of the aerofoil in its final shape and a second shaper that is capable of conforming to a second face of the aerofoil in its final shape, the second face being opposite to the first face.

For example, the polymer is thermosetting.

The invention also relates to a method for shaping an aerofoil of a blade made of composite material consisting of a fibrous reinforcement and a polymer surrounding the fibrous reinforcement, the blade including a root intended to be housed in a cavity of a rotor and an aerofoil that radially extends the root.

According to the invention, the method comprises the following steps:
(a) A tooling is provided that comprises at least one shaper, a heating device and a device for positioning the at least one shaper, the at least one shaper being shaped to conform to a portion of the aerofoil in its final shape;
(b) The portion is deformed by pressure against the at least one shaper using the positioning device;
(c) Simultaneously with step (b), the portion is heated by the heating device to a temperature close to the glass transition temperature of the polymer until the portion takes its final shape;
(d) After step (c), the heating is stopped and the portion is allowed to cool to ambient temperature while maintaining the deformation of the portion in its final shape;
(e) After step (d), the deformation of the portion is stopped.

For example, the positioning device comprises a tarpaulin and a vacuum pump, and in step (b) the at least one shaper is held against the portion using the tarpaulin and the vacuum pump.

The invention will be well understood and its advantages will be clearer upon reading the following detailed description of embodiments shown as non-limiting examples. The description refers to the appended drawings in which:

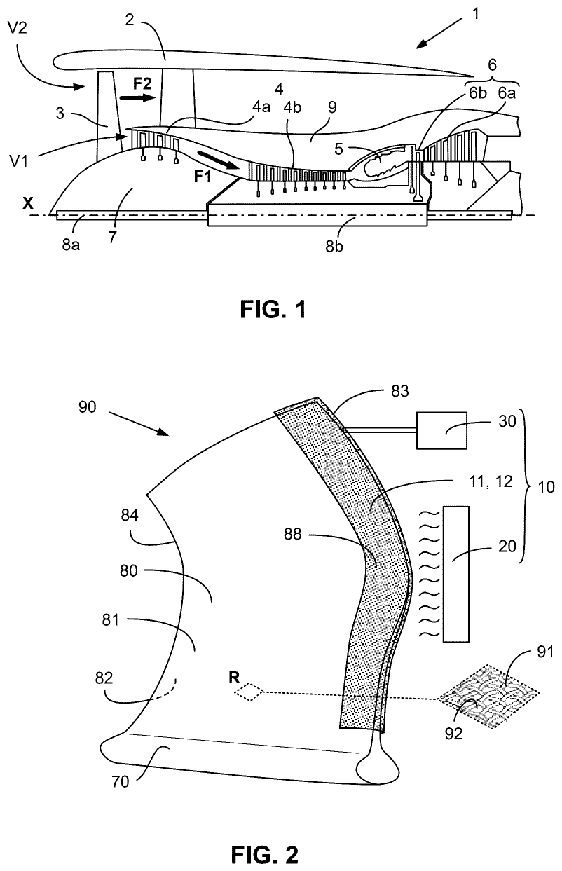

FIG. 1 is a diagram of a turbomachine including blades made of composite material on which a tooling according to the invention can be used.

FIG. 2 is a perspective view of a blade with a tooling according to the invention on the leading edge of this blade.

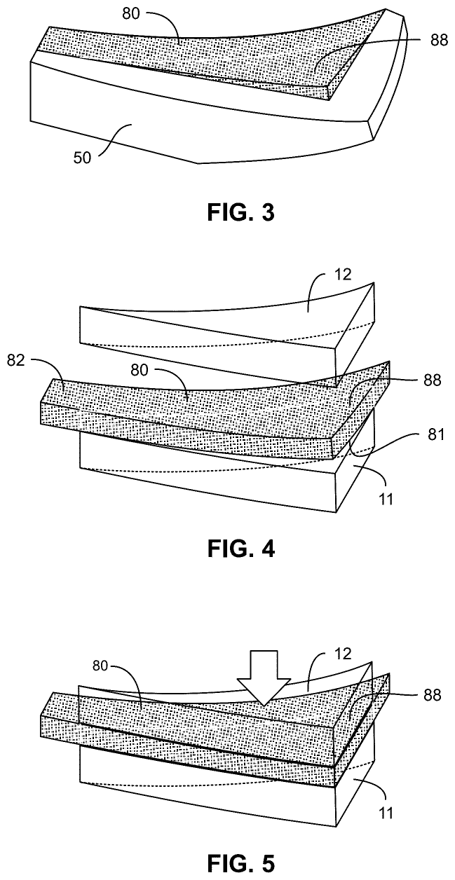

FIG. 3 is a perspective view of a part of a blade, a portion of which is deformed during its manufacturing.

FIG. 4 is a perspective view of the portion of the blade of FIG. 3 on which a tooling according to the invention is used, before this use.

FIG. 5 is a perspective view of the portion of the blade of FIG. 3 on which a tooling according to the invention is used, during this use.

### DETAILED DESCRIPTION OF THE INVENTION

A turbomachine 1 having a longitudinal axis X that is its axis of rotation is considered. In the description below, the terms “inner” and “internal” designate an element oriented toward the longitudinal axis X or disposed closer to this axis. The terms “outer” and “external” designate an element oriented in the direction opposite to the longitudinal axis X or disposed farther from this axis. The terms “upstream” and “downstream” are with respect to the direction of circulation of the air and of the gases during the operation of the turbomachine, that is to say from left to right in the drawings. The term “radial” designates a position or a direction in a transverse plane perpendicular to the longitudinal axis X.

As an example, the invention is described in the case in which the turbomachine 1 is a two-spool bypass turbomachine. FIG. 1 illustrates such a turbomachine 1, according to a longitudinal view. This turbomachine 1 includes a nacelle 2 that surrounds a fan 3 including aerofoils and located upstream of the turbomachine 1. The turbomachine 1 includes rotor shafts (8a, 8b) which extend along the longitudinal axis X and which carry the rotor elements of the turbomachine 1, a hub 7 coaxial to these rotor shafts (8a, 8b), and an inner casing 9 which is coaxial to the hub 7 and located radially to the outside of this hub 7 and downstream of the propeller of the fan 3. The nacelle 2 is located radially to the outside of the inner casing 9.

During normal operation of the turbomachine 1, a flow of air (called bypass flow F2) circulates in an annular duct, called second duct V2, which extends between the inner casing 9 and the nacelle 2. Another annular duct, called first duct V1 (in which a flow of air F1 circulates), extends between the hub 7 and the inner casing 9. The first duct V1 comprises downstream of the fan 3 a compressor 4 and a combustion chamber 5. This compressor 4 comprises upstream a low-pressure compressor 4a and downstream a high-pressure compressor 4b. The air compressed by the compressor 4 enters the combustion chamber 5 downstream and is mixed with fuel before being burned therein. The hot gases coming from this combustion are then expanded in a turbine 6 in the first duct V1 and make this turbine rotate. This turbine 6 comprises a high-pressure turbine 6b which is located downstream of the combustion chamber 5 then a low-pressure turbine 6a located downstream of the high-pressure turbine 6b. The mobile turbine blades of the high-pressure turbine 6b and of the low-pressure turbine 6a are mounted on discs which are themselves mounted on a second rotor shaft 8b, and which thus drive this second rotor shaft 8b in rotation. The mobile turbine blades of the low-pressure turbine 6a are mounted on discs which are themselves mounted on a first rotor shaft 8a, and which therefore drive this first rotor shaft 8a in rotation. The first rotor shaft 8a drives the rotor elements of the hub 7 which carry the mobile blades of the low-pressure compressor 4a and the propeller of the fan 3 in rotation. The second rotor shaft 8b drives the mobile blades of the high-pressure compressor 4b in rotation. The rotation of the propeller of the fan 3 contributes, with the ejection at high speed of the gases at the outlet of the combustion chamber 5, to the propulsion of the turbomachine 1.

Certain blades 90 of the turbomachine 1, in particular the blades 90 of the propeller of the fan 3, are manufactured from composite material for reasons of lightness and mechanical strength. These blades 90 are located in the less hot zones of the turbomachine 1 since they comprise a polymer matrix 92, for example a thermosetting polymer.

Such blades 90 are manufactured in a first step by weaving of a fibrous preform 91 (also called fibrous reinforcement), for example three-dimensional weaving of fibres such as carbon fibres. Alternatively, the fibrous preform 91 consists of a plurality of two-dimensional fibre weaving, or more generally a plurality of long fibres. For example in a second step, this preform 91 is then shaped in a mould and embedded in a polymer matrix 92 (the reference 92 indifferently designates the polymer or the polymer matrix) which consists of a polymer injected into the mould while being heated in order to obtain, after cooling, a composite part. The polymer (also called resin) is for example a thermosetting polymer such as epoxy. Alternatively, this polymer 92 is a thermoplastic. This second step is carried out for example by resin transfer moulding (RTM). In a third step a part that covers the leading edge 83 of the aerofoil 80 is applied onto the blade 90. Optionally, a protective film, for example made of polyurethane, and/or an anti-erosion layer of paint is also applied onto all or part of the aerofoil 80. A process of modifying the surface of the aerofoil 80, for example sandblasting, can also be applied before the part that covers the leading edge 83 and/or before the painting in order to improve the adhesion on the composite substrate. In a fourth step, in order to consolidate the blade 90, the blade is held in shapers, for example in a mould 50, and the blade is heated in an autoclave to above 150° C. in order to polymerise the polymer. The shapers contribute to maintaining the geometry of the blade 90 during this heating cycle. The blade 90 is then cooled in order to obtain the finished blade. The blade 90 comprises a root 70 intended to be housed in a cavity of a rotor of the turbomachine 1 and an aerofoil 80 that radially extends the root 70. The aerofoil 80 comprises a first face 81 and a second face 82 opposite to the first face 81. The first face 81 and the second face 82 meet at the leading edge 83 and at the trailing edge 84. Such a blade is visible in FIG. 2. An enlargement of the region R of the aerofoil 80 shows the woven fibres of the fibrous reinforcement 91 and the matrix 92.

The case is considered in which a portion 88 of the aerofoil 80, after the cycle of heating of the blade 90 in the autoclave, does not have the desired final shape. It is then necessary to give this portion 88 the desired final shape again. For this, a tooling 10 for shaping the aerofoil 80 according to the invention is used. This tooling 10 comprises at least one shaper 11, 12, a heating device 20 and a device 30 for positioning this or these shapers 11, 12. The shaper(s) 11, 12 are shaped, that is to say dimensioned and geometrically formed to conform to the portion 88 in its desired final shape. Thus, the portion 88 takes its final shape when it is heated by the heating device 20 to a temperature close to the glass transition temperature T_{g} of the polymer 92 and simultaneously applied against the shaper(s) 11, 12 by the positioning device 30.

The portion 88 can be a part or the entirety of an edge of the aerofoil 80. FIG. 2 illustrates the case in which the portion 88 is the entire leading edge 83 of the aerofoil 80. The tooling 10 comprises a single V-shaped shaper 11 in which the leading edge 83 is housed and which covers the first face 81 and the second face 82 (hidden in the drawing) of the aerofoil 80 over the entire length of the leading edge 83. The bottom of the V of the shaper conforms to the leading edge 83, one inner face of the V of the shaper 11 is against the first face 81, and the other inner face of the V of the shaper 11 is against the second face 82. The shaper 11 is shown in transparent grey. Alternatively, the tooling 10 comprises a first shaper 11 that is capable of conforming to the first face 81 of the portion 88 of the aerofoil 80 in its desired final shape and a second shaper 12 that is capable of conforming to the second face 82 of the portion 88 of the aerofoil 80 in its desired final shape, the portion 88 being compressed between these two shapers 11, 12.

The positioning device 30 is shown schematically in FIG. 2. The positioning device 30 can be of any kind as long as it allows to bring the shaper(s) 11, 12 closer to the portion 88 to deform this portion 88. For example, the positioning device 30 is a mechanical or hydraulic system that presses the shaper(s) 11, 12 against the portion 88. For example, the positioning device 30 comprises a piston. For example, the positioning device 30 comprises on the one hand a tarpaulin that covers the portion 88 and the shaper(s) 11, 12 and a support, and on the other hand a vacuum pump that creates a vacuum in the cavity defined by the tarpaulin and the support in order to press the shaper(s) 11, 12 against the portion 88. For example, the positioning device 30 is an autoclave and the heating device 20 (see below) is part of this autoclave. In this case, the positioning device 30 includes a tarpaulin that covers the portion 88 and the shaper(s) 11, 12 and a support.

The heating device 20 is shown schematically in FIG. 2 and is, in a known manner, capable of heating the portion 88 to a temperature close to the glass transition temperature T_{g} of the polymer 92 of the matrix. This heating is carried out for example by radiation or conduction. The portion 88 is then, under the stress (pressure, torsion) of the shapers 11, 12 and the action of the heat released by the heating device 20, deformed to take its desired final shape.

In reference to FIGS. 3 to 5 which show a part of an aerofoil 80, the case is described in which the portion 88 is a corner of the aerofoil 80 (this portion is delimited by a white line in these drawings). As illustrated in FIG. 3, at the end of the manufacturing of the blade 90, the corner of the aerofoil 80 (delimited by a white line) protrudes out of the cavity of the mould 50 while it should be flush with the surface of the mould 50. The blade 90 (shown in grey) is removed from the mould 50, and the first face 81 of the aerofoil 80 is placed against a first shaper 11 which is shaped to conform to this first face 81 in its desired final shape, and a second shaper 12 is placed opposite the second face 82 of the aerofoil 80, as illustrated in FIG. 4. The second shaper 12 is shaped to conform to this second face 82 in its desired final shape. For example, the second shaper 12 is a counterform of the first shaper 11. The second shaper 12 is then brought closer to the first shaper 11 as illustrated in FIG. 5 using the positioning device 30 (not shown), according to the direction of the arrow, so that the portion 88 is sandwiched between the shapers 11, 12. Simultaneously, the portion 88 is heated, and it deforms under the action of the shapers 11, 12 to take its desired final shape. For the sake of clarity the shapes 11, 12 are shown transparently.

The invention also relates to a method for shaping an aerofoil 80 of a blade 90 using a tooling as described above (step (a)). In a step (b), the portion 88 is deformed by pressure against the shaper(s) 11, 12 using the positioning device 30. In a step (c), simultaneously with step (b), the portion 88 is heated by the heating device 20 to a temperature close to the glass transition temperature T_{g} of the polymer 92 until the portion 88 takes its final shape. Step (c) lasts the time necessary for this deformation of the portion 88. In a step (d) after step (c), the heating is stopped and the portion 88 is allowed to cool to ambient temperature while maintaining the deformation of the portion 88 in its final shape using the positioning device 30. In a step (e) after step (d) the deformation of the portion 88 is stopped. Step (c) can begin before or after step (b). Advantageously step (c) begins before step (b) in order to facilitate the deformation of the portion 88. During the deformation of the portion 88, the rest of the aerofoil 80 is held in position so that only the portion 88 is deformed.

1-9. (canceled)

10. Tooling for shaping an aerofoil of a blade made of composite material consisting of a fibrous reinforcement and a polymer surrounding said fibrous reinforcement, said blade including a root configured to be housed in a cavity of a rotor and an aerofoil that radially extends said root, said tooling comprising:
at least one shaper;
a heating device; and
a device for positioning said at least one shaper,
said at least one shaper being shaped to conform to a portion of said aerofoil in its final shape so that said portion takes its final shape when it is heated by said heating device to a temperature close to a glass transition temperature of said polymer and simultaneously deformed by said at least one shaper using said positioning device.

11. The shaping tooling according to claim 10, wherein said positioning device comprises a tarpaulin and a vacuum pump.

12. The shaping tooling according to claim 10, wherein said portion is at least a part of an edge of said aerofoil.

13. The shaping tooling according to claim 12, wherein said edge is a leading edge of said aerofoil.

14. The shaping tooling according to claim 10, wherein said portion is an entirety of an edge of said aerofoil.

15. The shaping tooling according to claim 14, wherein said edge is a leading edge of said aerofoil.

16. The shaping tooling according to claim 10, wherein said at least one shaper comprises a first shaper which is configured to conform to a first face of said aerofoil in its final shape and a second shaper which is configured to conform to a second face of said aerofoil in its final shape, said second face being opposite to said first face.

17. The shaping tooling according to claim 10, wherein said polymer is thermosetting.

18. A method for shaping an aerofoil of a blade made of composite material consisting of a fibrous reinforcement and a polymer surrounding said fibrous reinforcement, said blade including a root configured to be housed in a cavity of a rotor and an aerofoil that radially extends said root, said method comprising:
(a) providing a tooling that comprises at least one shaper, a heating device, and a device for positioning said at least one shaper, said at least one shaper being shaped to conform to a portion of said aerofoil in its final shape;
(b) deforming said portion by pressure against said at least one shaper using said positioning device;
(c) heating, simultaneously with step (b), said portion by said heating device to a temperature close to a glass transition temperature of said polymer until said portion takes its final shape;
(d) stopping, after step (c), said heating and said portion is allowed to cool to ambient temperature while maintaining the deformation of said portion in its final shape;
(e) stopping, after step (d), the deformation of said portion.

19. The method according to claim 18, wherein said positioning device comprises a tarpaulin and a vacuum pump and, in step (b), said at least one shaper is held against said portion using said tarpaulin and said vacuum pump.
